(19) United States
(12) Patent Application Publication
(10) Pub. No.: US 2015/0286987 A1
(43) Pub. Date: Oct. 8, 2015

(54) Shut-In Communications System

(71) Applicant: Steven M. Richey, Morristown, TN (US)

(72) Inventor: Steven M. Richey, Morristown, TN (US)

(21) Appl. No.: 14/245,592

(22) Filed: Apr. 4, 2014

(51) Int. Cl. G06Q 10/10; G06Q 50/22

(52) U.S. Cl. CPC G06Q 10/10; G06Q 50/22; G06Q 10/1091

(57) ABSTRACT

A facilitator, physically present with a patient, uses a portable device or handheld device (such as a laptop, a tablet computer, a smartphone, or a similar device) to connect wirelessly to a web-based application. This web-based application communicates with a designated or pre-selected number of other applications—such as an e-mail service, a TWITTER account, and a FACEBOOK account. In some embodiments and for some applications, the web-based application retrieves data from the other applications—for example, retrieving e-mails from an e-mail service. In some embodiments and for some applications, the web-based application signs in the patient to that patient's account, e.g., TWITTER account or a FACEBOOK account. The web-based application and the facilitator then assist the patient in reading messages, in viewing pictures and video, and in composing and sending messages to other persons through the various applications accessed through the app.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The present invention relates generally to care management and more particularly to systems, methods, and devices to facilitate communication with and care for elderly patients.

2. Description of the Related Art

Shut-ins and elderly patients may live alone or with another aged partner. Oftentimes, the children of the elderly and other family members of the elderly live in a different residence, sometimes in another state, or another country. The geographic separation of family members has increased the difficulty of communicating with elderly family members. Further, due to deterioration of memory, the elderly tend to forget certain things, like anniversaries and birthdays, and to sometimes lose track of the passage of time.

In addition, much of the aging population is not accustomed to operating electronics or devices to enable frequent communication and interaction with children or other family members living remotely via e-mail or the like. In some situations, the older generation may not be used to using telephonic devices such as the fax machine for communication. Thus, maintaining frequent communication with elder parents that live at a distance remains difficult.

Furthermore, the children of elderly citizens typically have a career and young children of their own to watch over. Even if the aging population had other nearby family members, it would be difficult in practice for the family member to provide adequate care for the aging parent on a regular basis. Additionally, the cost of assisted living for senior citizens is high and the elderly tend to prefer to live independently in their own homes.

U.S. Pat. No. 6,757,358, issued to Kondziela, discloses methods and apparatus for providing a monitoring service using a speakerphone and monitoring device coupled by a telephone line are described. A call is placed to the monitoring device and the speakerphone is then left off the hook. The monitoring device records received sounds and monitors for signals indicating an attempt to place a call. If DTMF tones corresponding to a phone number are received, the monitoring device initiates a call to the received phone number and bridges the initiated call with the call from the speakerphone. A call can be placed to the monitoring device to access recordings of audio from the speakerphone, monitor sounds from the speakerphone in real time and/or select stories, music or messages to be supplied by the monitoring device to the speakerphone at times specified by the caller.

U.S. Patent Application Publication Number 2006/0190542, filed by Rhoades, discloses a system whereby e-mail communication between an elderly individual and registered friends and family is facilitated by displaying photographs received by e-mail from registrants on a monitor display screen, displaying visual indicators on said screen in association with photographs of registrants from whom e-mails have been received, and providing a selection means for selecting a photograph having an associated visual indicator. Upon selection, text e-mails received from registrants are converted to an audio format and the e-mails are played. The individual can also send recorded e-mails to a registrant whose photograph is selected. When an individual initially registers with the system, an e-mail is sent to the user's primary account manager, e.g., a relative, who sends a photograph to the user and invites the user's friends to register and send a photograph to the user's e-mail address.

U.S. Patent Application Publication Number 2008/0294462, filed by Nuhaan and Rarick, discloses systems, methods and apparatuses of facilitating web-based interactions between an elderly and caregivers are described in this application. In one aspect, embodiments of the present disclosure include a method, which may be implemented on a system, of providing care through facilitating interactions between a set of service subscribers including an elderly and one or more caregivers, via an online networking platform.

U.S. Patent Application Publication Number 2009/0307009, filed by Nuhaan and Rarick, discloses systems and methods for enabling caregivers to communicate with care-receivers and share information and data are described. The care-receiver may use a family-oriented networking platform as it provides an easy and intuitive way to stay in touch with their families and healthcare professionals, allowing caregivers to use their preferred means of digital communication to communicate with the care-receivers.

U.S. Patent Application Publication Number 2012/0179485, filed by Saneii, discloses systems and methods for managing the care of care receivers using a care management system are disclosed. One embodiment includes a care management server configured to communicate with at least one care provider client, where the care provider client is configured to provide a user interface for receiving care management instructions; where the care management server is configured to receive care management instructions from the at least one care provider client and store the care management instructions in a care management database; receive data concerning the status of a care recipient and store the received data concerning the status of the care recipient in the care management database; analyze the data concerning the status of the care recipient within the care management database in accordance with the care management instructions; and send notifications to the care provider client based upon the analysis of the care management database.

### BRIEF SUMMARY OF THE INVENTION

The present general inventive concept, in several of its embodiments, includes systems and methods in which a facilitator, physically present with a shut-in or patient, uses a portable device or handheld device (such as a laptop, a tablet computer, a smartphone, or a similar device) to connect wirelessly to a web-based application. This web-based application communicates with a designated or pre-selected number of other applications—such as an e-mail service, a TWITTER account, and a FACEBOOK account. In some embodiments and for some applications, the web-based application retrieves data from the other applications—for example, retrieving e-mails from an e-mail service. In some embodiments and for some applications, the web-based application signs in the patient to that patient's account, e.g., TWITTER account or a FACEBOOK account. The web-based application and the facilitator then assist the patient in reading messages, in viewing pictures and video, and in composing and sending messages to other persons through the various applications accessed through the app.

In some example embodiments of the present general inventive concept, a system for facilitating electronic communication with a patient includes a barcode containing patient information; a portable device to read said barcode and retrieve said patient information; a computer system to receive said patient information from said portable device and to access account information associated with said patient information; and a display device to receive account information from said computer system and to access and display a web-based application, said web-based application including an account associated with account information from said computer system, said display device displaying a page with information from said web-based application and said account, said web-based application providing access to data associated with said patient, said data being stored by other web-based applications.

In some embodiments, said portable device and said display device are included in a single apparatus.

In some embodiments, said web-based application maintains a record of the activities performed through the web-based application and a record of how much time is spent using the web-based application.

In some embodiments, said portable device scans said barcode to begin a session using the web-based application.

In some embodiments, said portable device scans said barcode to end a session using the web-based application.

In some embodiments, said other web-based applications include at least one e-mail application.

In some embodiments, said other web-based applications include at least one web-based application selected from the group consisting of FACEBOOK, TWITTER, SKYPE, ITUNES, and IPHOTO.

In some example embodiments of the present general inventive concept a method for facilitating electronic communication with a patient includes using a portable device to scan a barcode containing patient information; said portable device sending said patient information to a computer system; said computer system accessing account information associated with said patient information; said computer system sending said account information to a display device; and said display device accessing and displaying a web-based application, said web-based application including an account associated with account information from said computer system, said display device displaying a page with information from said web-based application and said account, said web-based application providing access to data associated with said patient, said data being stored by other web-based applications.

In some embodiments, said portable device and said display device are included in a single apparatus.

In some embodiments, said web-based application maintains a record of the activities performed through the web-based application and a record of how much time is spent using the web-based application.

In some embodiments, the portable device to scan a barcode containing patient information begins a session using the web-based application.

In some embodiments, said portable device scans said barcode a second time to end the session using the web-based application.

In some embodiments, said other web-based applications include at least one e-mail application.

In some embodiments, said other web-based applications include at least one web-based application selected from the group consisting of FACEBOOK, TWITTER, SKYPE, ITUNES, and IPHOTO.

### BRIEF DESCRIPTION OF THE DRAWINGS

The above-mentioned and additional features of the invention will become more clearly understood from the following detailed description of the invention read together with the drawings in which:

FIG. 1 is a block diagram illustrating one example embodiment of a method for facilitating electronic communication with a patient according to the present general inventive concept; and

FIG. 2 is a block diagram illustrating one example embodiment of a system for facilitating electronic communication with a patient according to the present general inventive concept.

### DETAILED DESCRIPTION OF THE INVENTION

The present general inventive concept, in several of its embodiments, includes systems and methods that assist a facilitator or caregiver (hereinafter collectively “facilitator”) in helping a shut-in or patient (hereinafter generally “patient”) access and use communication platforms in order to read messages or receive information from other persons (such as loved ones) and to send messages to other persons. In some embodiments, a facilitator, physically present with a patient, uses a portable device or handheld device (such as a laptop, a tablet computer, a smartphone, or a similar device) to connect wirelessly to a web-based application (hereinafter simply “app”). This app communicates with a designated or pre-selected number of other applications—such as an e-mail service, a TWITTER account, and a FACEBOOK account. In some embodiments and for some applications, the app retrieves data from the other applications—for example, retrieving e-mails from an e-mail service. In some embodiments and for some applications, the app signs in the patient to that patient's account, e.g., TWITTER account or a FACEBOOK account. The app and the facilitator then assist the patient in reading messages, in viewing pictures and video, and in composing and sending messages to other persons through the various applications accessed through the app.

In some embodiments, the app maintains a record of the activities performed through the app and of how much time the facilitator spent with the patient using the app.

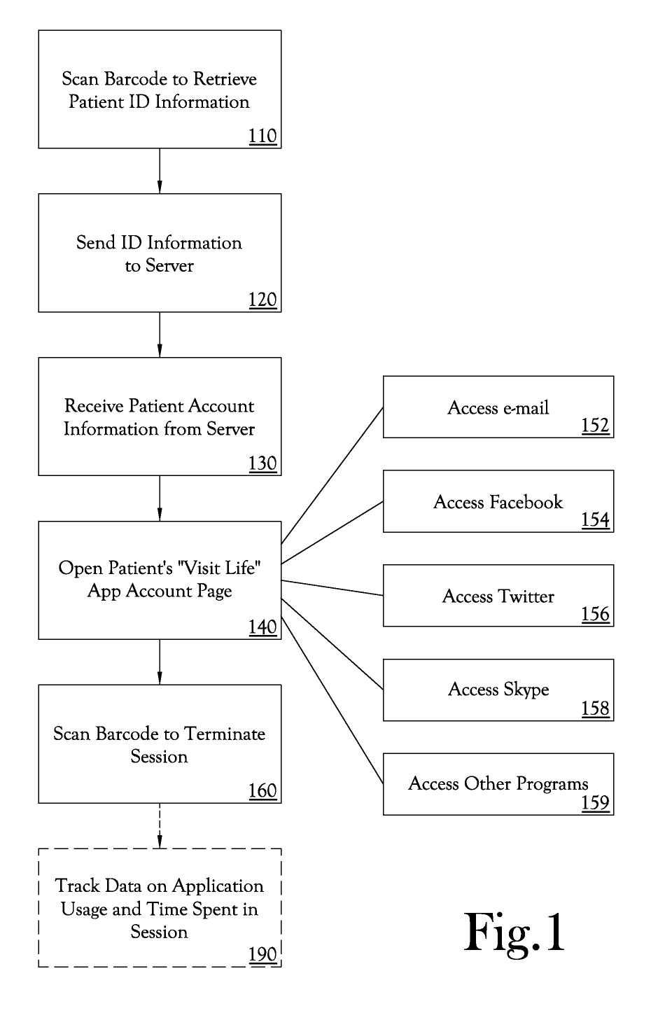

One example embodiment of the present general inventive concept is illustrated generally in FIG. 1. As shown in the block diagram of FIG. 1, a facilitator approaches a patient's living area or bed. The facilitator uses a portable device to scan a barcode 110. The barcode contains identity or ID information, indicating to the portable device the identity of the patient; scanning the barcode allows a computer system within or connected to the device to send the ID information to a server 120 and to then retrieve from the server information associated with that patient 130. The computer system accesses the “Visit Life” App and uses the ID information from the barcode to access an account associated with that ID information and that particular patient. Once the “Visit Life” App has accessed the patient's account, the “Visit Life” App retrieves information from the patient's account and displays that information as “Visit Life” App account page 140, which generally is displayed on a screen of a laptop or tablet device (sometimes, but not always, the same portable device used to scan the barcode). The “Visit Life” App account page 140 functions as a portal to access the patient's e-mail account 152, FACEBOOK account 154, TWITTER account 156, SKYPE account 158, and other accounts 159. Using the “Visit Life” App account page, the facilitator is able to help the patient in, for example, reading e-mail messages from family members, reviewing the patient's FACEBOOK news feed and wall, reading Tweets from the patient's TWITTER account, and viewing photos and video from various sources. Also, using the “Visit Life” App account page, the facilitator is able to help the patient in composing e-mail messages, wall posts, and responses to information received. When the session is concluded, generally the facilitator scans the barcode a second time 160 to close the “Visit Life” App account page for that patient.

In some embodiments, the “Visit Life” App maintains a record 190 of the activities performed through the app and of how much time the facilitator spent with the patient using the app.

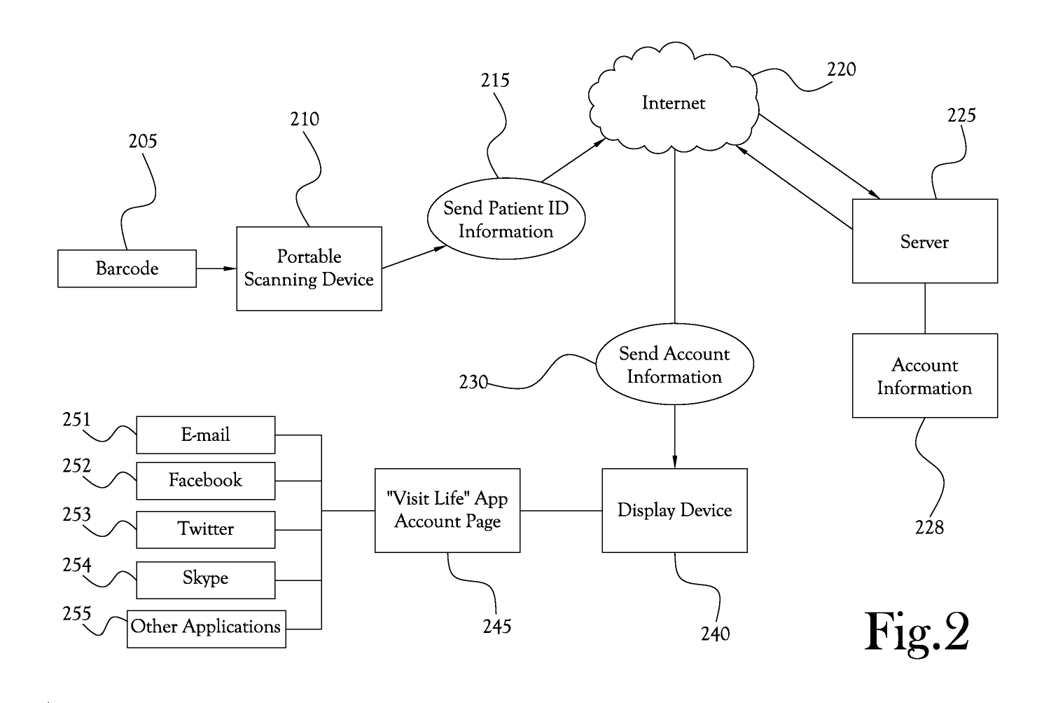

FIG. 2 shows a block diagram representing in general form a system according to one example embodiment of the present general inventive concept. A barcode 205 is read by a portable scanning device 210, which reads patient ID information from the barcode and sends that ID information 215 to a server 225 over the Internet 220, generally through a WiFi connection. The server 225 uses the patient ID information to access account information 228 for that patient, and then sends 230 that account information to a display device 240. A facilitator is then able to use the display device 240 to bring up a “Visit Life” App account page 245 for that patient. The “Visit Life” App account page 245 then functions as a portal allowing the facilitator and the patient to access the patient's e-mail 251, FACEBOOK account 252, TWITTER account 253, SKYPE account 254, and other web-based applications 255 and communications systems.

In some embodiments, the “Visit Life” App maintains a record of the activities performed through the App and of how much time the facilitator spent with the patient using the App. The “Visit Life” App can then communicate this App use data and time data to the patient's children or to another payer or client of the service. In this way, the App use data and time data can be useful for monitoring quality control, for ensuring that a facilitator is spending sufficient time with a patient, for the collection of statistical information on the efficiency of facilitators within an organization, and for similar purposes.

Some embodiments of the present general inventive concept include additional features. For example, in some embodiments, the “Visit Life” App will alert a facilitator to upcoming or presently occurring events (like birthdays) and will prompt the facilitator to take actions appropriate to those events (e.g., writing an e-mail message to a grandchild on that grandchild's birthday). The “Visit Life” App may also prompt the facilitator to take other actions on certain occasions, e.g. to deliver a gift, to bring flowers to the patient, to set up a telephone call to a certain person, to set up a SKYPE session with a certain person, etc.

Some embodiments of the “Visit Life” App include a dictation or transcription feature to assist patients with restricted or impaired motor function in composing e-mail messages and other written messages.

In some embodiments, the facilitator scans the bar code at the beginning of a session, and the facilitator scans the bar code again to terminate a session. This begin-time data and end-time data can then be stored for billing purposes and the like.

From the foregoing description, it will be recognized and appreciated that systems and methods for facilitating electronic communication with a patient are provided. Such systems and methods have enormous potential for assisting certain patients, such as elderly patients in nursing homes, in maintaining communication with loved ones, relatives, and friends who live in distant locations. Such systems and methods also may help patients follow events happening in the lives of their loved ones, relatives, and friends. The present general inventive concept has applicability in assisting persons who are not regular users of web-based communications systems or do not have great familiarity with computers, smart phones, and similar devices.

While the present invention has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A system for facilitating electronic communication with a patient comprising:
a barcode containing patient information;
a portable device to read said barcode and retrieve said patient information;
a computer system to receive said patient information from said portable device and to access account information associated with said patient information; and
a display device to receive account information from said computer system and to access and display a web-based application, said web-based application including an account associated with account information from said computer system, said display device displaying a page with information from said web-based application and said account, said web-based application providing access to data associated with said patient, said data being stored by other web-based applications.

2. The system of claim 1 wherein said portable device and said display device are included in a single apparatus.

3. The system of claim 1 wherein said web-based application maintains a record of the activities performed through the web-based application and a record of how much time is spent using the web-based application.

4. The system of claim 1 wherein said portable device scans said barcode to begin a session using the web-based application.

5. The system of claim 4 wherein said portable device scans said barcode to end a session using the web-based application.

6. The system of claim 1 wherein said other web-based applications include at least one e-mail application.

7. The system of claim 1 wherein said other web-based applications include at least one web-based application selected from the group consisting of FACEBOOK, TWITTER, SKYPE, ITUNES, and IPHOTO.

8. A method for facilitating electronic communication with a patient comprising:
using a portable device to scan a barcode containing patient information;
said portable device sending said patient information to a computer system;
said computer system accessing account information associated with said patient information;
said computer system sending said account information to a display device; and
said display device accessing and displaying a web-based application, said web-based application including an account associated with account information from said computer system, said display device displaying a page with information from said web-based application and said account, said web-based application providing access to data associated with said patient, said data being stored by other web-based applications.

9. The method of claim 8 wherein said portable device and said display device are included in a single apparatus.

10. The method of claim 8 wherein said web-based application maintains a record of the activities performed through the web-based application and a record of how much time is spent using the web-based application.

11. The method of claim 8 wherein said portable device to scan a barcode containing patient information begins a session using the web-based application.

12. The method of claim 11 further comprising said portable device scanning said barcode a second time to end the session using the web-based application.

13. The method of claim 8 wherein said other web-based applications include at least one e-mail application.

14. The method of claim 8 wherein said other web-based applications include at least one web-based application selected from the group consisting of FACEBOOK, TWITTER, SKYPE, ITUNES, and IPHOTO.
